(19) United States
(12) Patent Application Publication
(10) Pub. No.: US 2005/0055599 A1
(43) Pub. Date: Mar. 10, 2005

(54) Identification of delivery objects

(76) Inventors: Oscar Bravo, Stockholm (SE); Marid Espinosa, Skogas (SE); Bengt Hagstrom, Alvsjo (SE); Kent Helgesson-Hanser, Huddinge (SE)

Correspondence Address: YOUNG & THOMPSON, 745 SOUTH 23RD STREET, 2ND FLOOR, ARLINGTON, VA, 22202, US

(21) Appl. No.: 10/501,410

(22) PCT Filed: Jan. 15, 2002
(86) PCT No.: PCT/SE02/00053

(51) Int. Cl. G06F 11/00

(52) U.S. Cl. 714/4

(57) ABSTRACT

The present invention relates to a system and method for enabling, in a system comprising a plurality of service providers and a plurality of network providers, for a network provider to manage information for supplying network services in a network. The invention is based on the idea that a control system receives an order from a service provider. The control system places the order at a network provider and registers information related to said order in registers. The registers can be located within, or outside, the telecommunication network. The product that corresponds to the order from the service provider is delivered, regardless of the network technology used by the network provider. This is possible due to the fact that the communication protocol employed by the service provider is adapted to the network technology used in the telecommunication network, based on predetermined registered network technology information.

### TECHNICAL FIELD OF THE INVENTION

The present invention relates to a system and method for enabling, in a system comprising a plurality of service providers and a plurality of network providers, for a network provider to manage information for supplying network services in a network.

### BACKGROUND ART

In telecommunication systems today, different actors provide services to their customers. In practice, a plurality of actors can together form a chain for providing the service to the subscriber. A service is delivered to the customer by way of a network provider connecting the equipment of the customer to the network and effectuating the required functions of the service.

A service provider manages the customer relations, develops, markets and sells telecommunication or data communication services, bills the customers and handles customer support. It is not necessary for the service provider to own or operate an own network.

A network provider manages, maintains and develops the network. The network provider activates telecommunication or data communication services, requested by the service provider, to the geographical addresses where the subscribers have their equipment. The network provider collects data from the network, which data is used as a basis for billing the subscribers for the delivered services.

For an actor described above, it is possible to establish business in geographic areas without having to provide his or her own equipment in said geographic areas. An actor which does not have an own network in a region can establish a business as a service provider. An actor who owns a network can take on the role of a network provider and offer said network to other actors, both service providers and retailers, which already have established customer relations. As a consequence of this, an actor attains agreements with other actors. In these agreements, the actor takes on the role that suits the actor best regarding geography, market aspects, legislation and technical competence. The role of the actor can also be a consequence of licensing. These roles implies that each actor has the technical competence to administer his or her relations to other parties in order to develop, market, sell deliver, maintain, follow up, charge and bill telecommunication services.

Systems used today are characterized by manual solutions. In practice, no appropriate interfaces exist between different providers or actors. Therefore, exchange of information is performed by means of facsimile or mail between operators. In some cases, interfaces based on a standard within ITU-T, the so called X-interface, have been used between operators. Other solutions for automating the interface between control systems have been used in the US in the so called Electronic Bonding Program.

A total solution, which automates the communication between the systems of the actors, and also the operation within the systems, has not been employed. Typically, the operation of each provider uses some form of computer support for carrying out certain parts of a telecommunication service delivery. Thus, in systems used today, the delivery process is divided in smaller activities, wherein each activity is performed manually by reading and writing different registers and network elements. Thereafter, the confirmation and reporting that some activity has been carried out is manually ordered.

In present telecommunication networks, different types of networks exist, which networks are designed according to completely different principles regarding traffic routing, traffic control, network addressing, signaling and allocation of network capacity for the user. One result of the differences in networks is that networks of different types are incompatible. A first user that wants to communicate with a second user, from a first network to a second network, must be certain that the second user is connected to a network of the same type as the first user. Another result of the differences is that the control systems for managing the networks also are different. Since the networks have been designed for certain types of traffic, the control systems have been designed to fit each network, respectively. A system for operating ATM switches can for example not be used for operating telephone switches, or vice versa. The actors in the telecommunication field must therefore develop competence in managing networks employing different network technologies and also competence in managing, maintaining and developing the control systems necessary for the network operation.

As mentioned hereinabove, a plurality of actors operates in the field of telecommunication today. The actors should be able to sell, deliver, maintain, follow up and bill the telecommunication services they provide their customers. It is an advantage for these actors to cooperate with each other in order to reach larger customer groups as well as being able to reach different geographical areas. This requires that the control systems in the networks associated with different actors enables cooperation. Traditional actors, which have been active for a long time, have a system heritage in the form of different networks and control systems for these. Formerly, these actors have had no need to separate the control systems supporting the service provider operation from the control systems supporting the network provider operation. The situation has rather been the opposite; rationalization of the control systems in networks has been advantageous for a traditional actor, since this has resulted in large scale benefits. An example of this is sale and delivery of telephone subscriptions. When selling telephone subscriptions, the seller can register information associated with the subscriber in a control system, which system is later used to order the functions necessary to deliver the service to the subscriber. These functions including, on one hand to connect the subscriber line to the appropriate switch equipment, and on the other hand to set data that activates the service at the telephone switch for this subscriber. By means of this procedure, data associated with the subscriber have been stored in the system containing information both about the access network and the service. Such a rationalization, which previously has been effective, today becomes an obstacle when the actors comprise different retailers, service providers and network providers. An actor comes up against difficulties in taking on different roles in different geographical areas and markets, since network data, customer information and service data are located in the individual control system associated with each actor.

One problem that has to be solved is that since the actors working in the field of telecommunication now takes on different roles as retailers, service providers and network providers, their control systems must be able to exchange customer information, service data and network data with the control systems of other actors.

Another problem that has to be solved is that operations such as sales, delivery, maintenance, follow-up and billing of telecommunication services now are performed in an ineffective way.

### SUMMARY OF THE INVENTION

An object of the present invention is therefore to solve the above given problems by providing an effective exchange of information between the different actors. The interfaces and the functions between the service provider systems and the network provider systems should be made as automated as possible, with as little human interaction as possible. The actors interacting with each other should be able to communicate regardless of network technologies employed in the systems.

This object is achieved by a control system for enabling, in a system comprising a plurality of service providers and a plurality of network providers, for a network provider to manage information for providing network services in a telecommunication network according to claim 1, a method for enabling, in a system comprising a plurality of service providers and a plurality of network providers, for a network provider to manage information for providing network services in a telecommunication network according to claim 9 and a computer-readable medium storing computer-executable components in accordance with claim 17. Preferred embodiments are defined by the dependent claims.

According to a first aspect of the invention, a control system is provided, wherein the control system is arranged to place an order, from a service provider, at a network provider. The control system registers information related to said order and delivers the product that corresponds to the order from the service provider, regardless of the network technology used by the network provider.

According to a second aspect of the invention, a method is provided, in which an order from a service provider is placed at a network provider. Information related to said order is registered and the product that corresponds to the order from the service provider is delivered, regardless of the network technology used by the network provider.

The invention is based on the idea that a control system receives an order regarding a product, which in the end will be realized as service, from a service provider. The control system places that order at a network provider and registers information related to said order in registers. The registers can be located within, or outside, the telecommunication network. The product that corresponds to the order from the service provider is delivered, regardless of the network technology used by the network provider. This is possible due to the fact that the communication protocol employed by the service provider is translated to the communication protocol of the network technology used in the telecommunication network, based on predetermined registered network technology information.

The registers located within, or outside, the telecommunication network contains information which enables the actors, such as retailers, service providers and network providers to exchange information in an effective way. For example, the service provider sells and registers subscriptions of a certain type of telecommunication service. The network provider will fetch the information from the register and deliver the required telecommunication service, thus providing the service to the customer. The service provider receives and registers customer complaints regarding service failures, and the network provider performs the trouble shooting and corrects the error. The network provider collects and registers data forming the basis for invoices while the service provider produces and sends the invoices to the customers. The service provider processes market information and statistics and performs analysis and forecasts concerning future service demands and registers this type of information, while the network provider uses the information for future network planning. It is practically possible for a service provider, with a customer base, to run his or her business with a laptop and a mobile phone, thereby accessing the control system, including registers containing required information, of the invention.

According to an embodiment of the invention, the control system is able to coordinate a plurality of network technologies simultaneously, based on the predetermined registered network information. When delivering a service, the control system might pass data to a plurality of networks, each network employing different technologies. The control system might receive components, which put together constitutes a service, from different networks. The control system is able to translate the protocol of the service provider to the protocol of each and every one of these different network technologies, by utilizing corresponding registered network information.

According to another embodiment of the invention, the control system registers and manages data associated with every product, from the time of receiving the product order from the service provider to time of delivery of the product to said service provider and later on, when the product is in use by its user. It is possible to monitor events associated with the product, by accessing the registered data. Examples of events are product function errors, customer use of the product and new functions added to the product after an order from the user.

According to further embodiments of the invention, the control system is capable of registering data associated with network resources installed in the network. On basis of this registered data, the control system can access status information about the network resources and book, connect and release network resources. A network resource is equipment comprising ports, channels, boards and interfaces, but also logic entities like net addresses and telephone numbers. By registering network resource data, it is also possible for the network provider to obtain, for example, a fault log pinpointing a certain rack, magazine or board in the telecommunication network. This type of information is considered very valuable for a network provider.

According to yet another embodiment of the invention, the control system is not only able to translate the protocol of the service provider to the protocols of the different network technologies, but is also able to adapt or translate the protocol to different network elements in the network, which network elements can have different versions, different manufacturers, be of different types and have different technical solutions. The adaption or translation is made based on predetermined registered network technology information, which information includes network element information.

According to yet a further embodiment of the invention, the control system is arranged to change or cancel the delivery of an ordered product to a service provider. The service provider might want to add features to an existing product. There is a possibility that the order cannot be executed due to incorrect order information or due to the fact that there are no resources available to execute the order.

According to another embodiment of the invention, the product is described by using at least one component. A component describes a group of attributes that must be set in a network of a certain technology in order to achieve the functions, features and behaviors required of a given product. A component is realized by resources within a network technology and many different components can be defined within a network technology. By employing this module concept of defining the product using components and resources, the product structure becomes smoother and more flexible. If a resource is added to the network or simply changed, it is not necessary to change the complete product. The specific resource in the product is changed, and this makes the product less sensitive to technology development. Needless to say, technology developments appear rather frequent in the field of telecommunication and data communication.

Further features of, and advantages with, the present invention will become apparent when studying the appended claims and the following description.

### BRIEF DESCRIPTION OF THE DRAWINGS

Exemplifying embodiments of the invention will be described in greater detail with reference to the accompanying drawings, in which:

FIG. 1 shows the interface between the service providers and the network providers according to an embodiment of the present invention;

FIG. 2 shows a service provider placing an order at a network provider in accordance with an embodiment of the present invention;

FIG. 3 is a simplified block diagram showing a control system according to an embodiment of the present invention;

FIG. 4 is a detailed block diagram showing a layered control system according to an embodiment of the present invention;

FIG. 5 is a block diagram showing an exemplified product layer included in FIG. 4;

FIG. 6 is a block diagram showing an exemplified production layer included in FIG. 4;

FIG. 7 is a block diagram showing an exemplified technology layer included in FIG. 4; and

FIG. 8 is a block diagram showing an exemplified adaption layer included in FIG. 4.

### DESCRIPTION OF THE PREFERRED EMBODIMENTS OF THE INVENTION

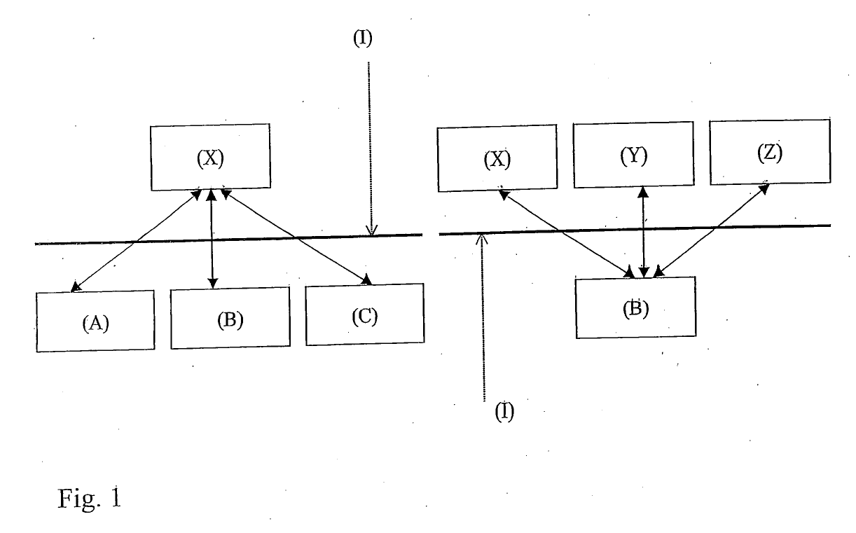

FIG. 1 shows the interface I which enables for a service provider X to exchange information with one, or more, network provider A, B, C and for a single network provider B to exchange information with one, or more, service provider X, Y, Z.

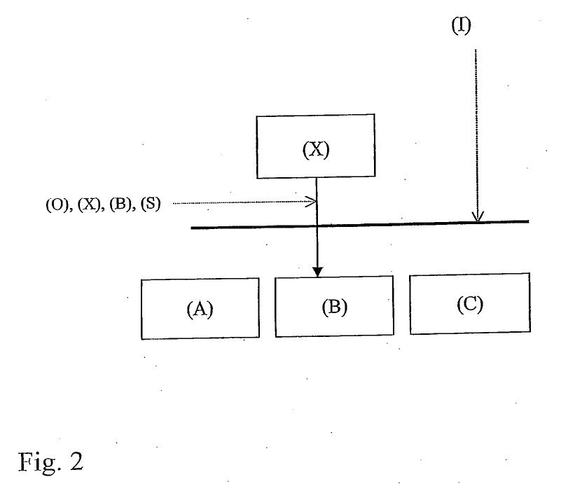

FIG. 2 shows a service provider X placing a product type order, i.e. a telecommunication service order, via the interface I. Every product type order regarding the service S is identified as an individual object O. In the product type order, the involved parties X and B and the service S of interest is included.

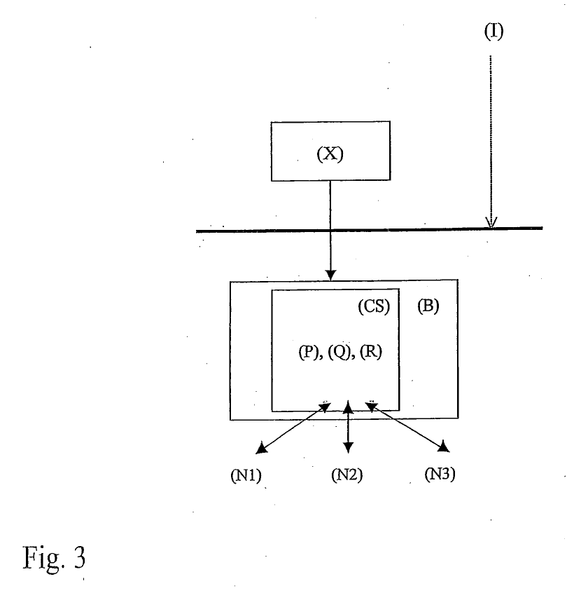

FIG. 3 shows a control system CS operating in the network of the network provider B, which control system CS is supplemented with functions such as:
(1) setting of data of elements built according to different network technologies,
(2) coordinate troubleshooting in different network technologies N1, N2, N3, and
(3) collection of data from networks employing different technologies P, Q, R.

These functions enable automatic processing of information exchanged via the interface I. Delivery of a certain service can comprise setting of data of elements built according to different network technologies, enabling the control system CS to handle different network technologies N1, N2, N3 for providing the delivery of a product. The correction of errors associated with a telecommunication service can result in the fact that elements built according to different network technologies need to be troubleshooted, implying that the control system CS must be able to coordinate troubleshooting in different network technologies N1, N2, N3, within the scope of one single order. Billing data used as a basis for invoices regarding the use of an individual service must be identified individually. In the billing data used as a basis for invoices, involved parts and the actual service delivered should appear. The billing of an individual service involves collection of data from networks employing different technologies. The control system CS should be able to coordinate different network technologies N1, N2, N3 when collecting data for billing.

For the sake of simplicity, the parties involved in the exchange of information will hereinafter be restricted to one service provider and one network provider. As is clearly understood by those skilled in the art, the present invention includes hardware such as computers, processors, memories and storage media etc. The computers or processors or some equivalents thereof, having computing capability, performs the steps comprised in the method according to the invention. Consequently, the means included by the system of the invention is implemented by these computers, processors or equivalents, which is arranged to perform the function of said means when executing appropriate software code. The present invention also includes software such as operating systems, file systems, communication protocols, databases etc. The description is functional, and thus excludes this type of equipment.

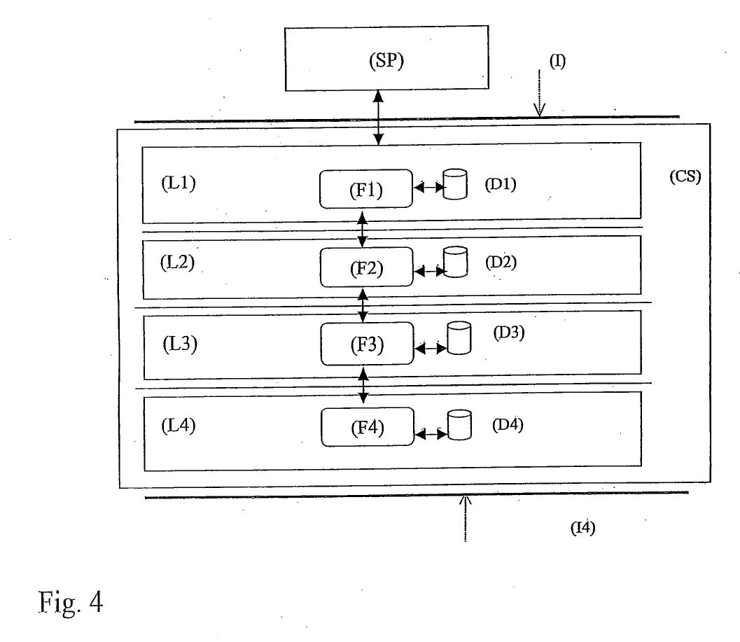

FIG. 4 shows an overview of the present invention. The overview comprises the following layers:
L1: Product layer
L2: Production layer
L3: Technology layer
L4: Adaption layer
   The layers form a hierarchy. The location of a layer L relative to another layer is such that a function block F included in each layer is only allowed to communicate with registers D within the same layer, or with a function block located in an adjacent layer. The layers will be described in the following.

The product layer L1 is responsible for receiving, identifying and organizing product type orders. An example hereof is orders, complaints or other product related inquiries. Depending on the inquiry, the product concept can represent a type or an instance of a certain type. The product layer is also responsible for deciding which activity function that should be addressed within the production layer.

The production layer L2 comprises one or more activity functions. Examples of activity functions include delivery, follow up and billing. A manager associated with the production layer is responsible for the coordination within an activity function.

The technology layer L3 comprises the technologies that the network provider employs to produce services. The technology layer is responsible for managing these network technologies, including server technologies. The layer therefore comprises a number of managers, each one managing one technology. Such technologies can be, for example, IP, ATM, DTM and ISDN. Since the managing of a certain technology includes a plurality of managing functions, such as configuration, maintenance, quality measurement, billing and security, there can exist more than one manager for every technology. Every manager is thus responsible to handle the technology combination and the activity function it is defined for. The information the technology layer is processing is dependent of the technology in question.

The adaption layer L4 keeps track of the network elements and server systems of different manufacture within an individual technology. The adaption layer is required since network elements and servers can be manufactured by different suppliers or since they support different versions of hardware and software. The responsibility of the adaption layer is to provide a common data model for network elements and server systems of different manufacture and versions. The adaption layer is also responsible that technical managers can communicate with, and control, network elements and server systems, regardless of manufacture and version.

In the following, a detailed description of the layers will be provided. The layers will be exemplified while providing automatic delivery of a service. This should by no means be seen as limiting the control system according to the invention to delivering a service.

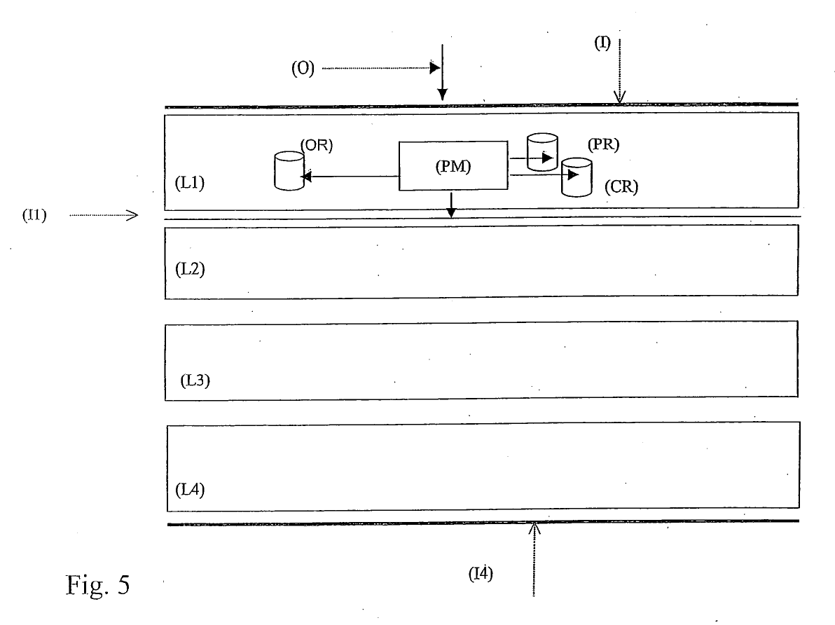

FIG. 5 shows a detailed description of the product layer L1. The product manager PM receives a product type order O via the interface I. The order O can be, for example, “ordering a new instance of a certain product” or “canceling a current product instance”. The product manager PM verifies that the order is valid with respect to the product type. This is done by checking the product register PR. The product register PR is arranged to store information about the products available for delivery, information defining the products regarding delivery maintenance, billing, follow-up and the like and information regarding the components that the products consist of. A component represents a group of rules and attributes that must be set on a network technology for the network to supply the properties, functions and behavior defined by the product. Via the interface I, it is possible to associate a verification to the correct call, a call to the correct session and a session to the correct customer system.

The product manager PM verifies that the order is valid for this specific customer by checking the customer register CR. The customer register CR stores information about the customers and which set of products the customers are entitled to order via the interface I. The product manager PM then creates and registers an order containing information such as product type, customer information, delivery date and delivery address, in the order register OR. The order register OR stores information regarding orders in process and delivery time information associated with orders not to be delivered immediately. A confirmation whether the product type order is accepted or not is sent to the service provider. Finally, the underlying production layer L2 is informed that an order needs to be executed. This is done via the production interface I1.

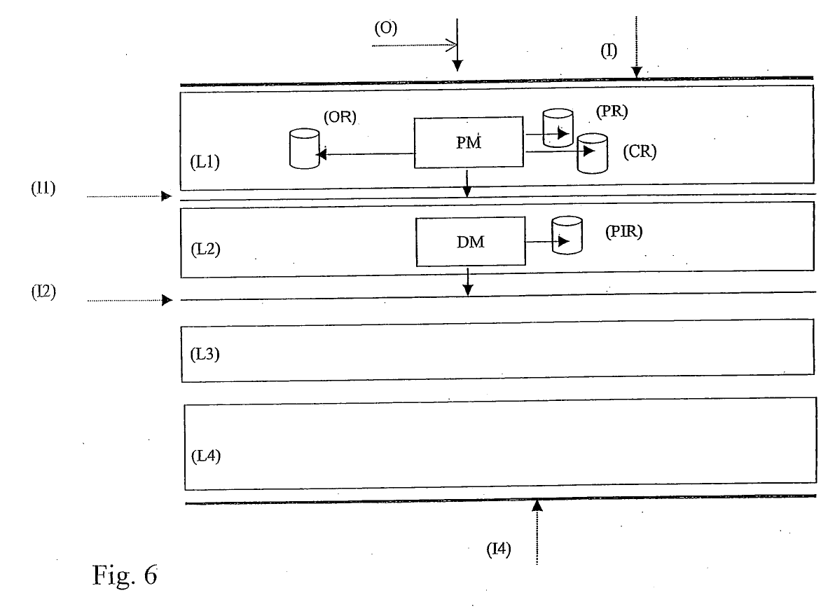

FIG. 6 shows a detailed description of the production layer L2. The delivery manager DM receives a call from the product manager PM via the production interface I1. The call can comprise information such as “current product instance inquiry”, “current order status” or “changing current product instance order”. The delivery manager DM verifies that the order is valid with respect to the status of the product instance relating to the product. This is done by checking the product instance register PIR. The product instance register PIR is arranged to store information concerning every specific delivery of a product, references to information concerning a specific delivery of a product, but which information, due to practical reasons, is stored in other registers, for example in the technology layer. Moreover, the product instance register PIR updates and keeps track of all information associated to a specific product delivery during the complete lifetime of the product.

The delivery manager DM executes the order of a product instance, and this implies that a new product instance can be created, updated, cancelled etc. depending on the order contents. The execution is performed in cooperation with the product instance register PIR. A confirmation whether the order is executed or not is sent to the product manager PM. There is a possibility that the order cannot be executed due to incorrect order information or due to the fact that there are no resources available to execute the order. Finally, the underlying technology layer L3 is informed that an order needs to be executed. This is done via the technology interface I2.

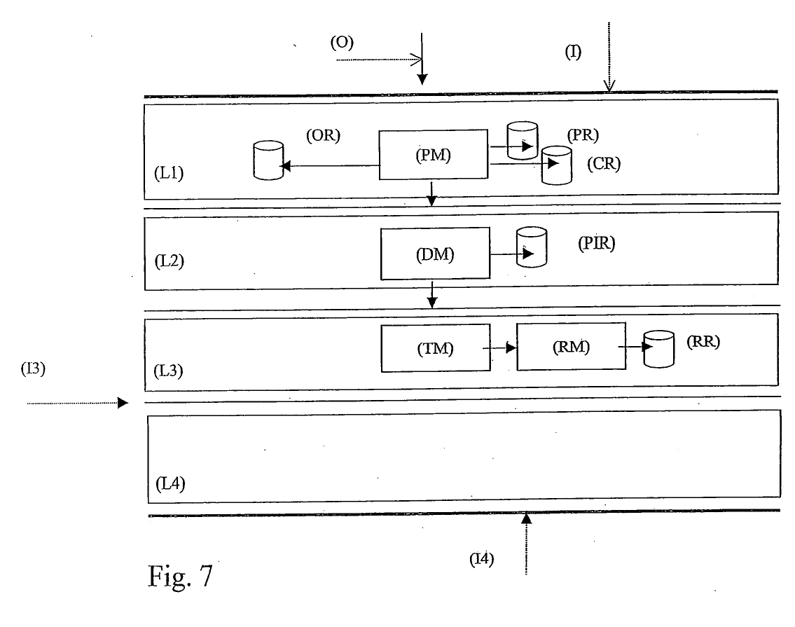

FIG. 7 shows a detailed description of the technology layer L3. Essentially, there is one technology manager TM for every network technology. This means that there will be as many technology managers TM as there are technologies to manage when delivering a product. The technology managers TM coordinates activation of the network resources necessary to deliver a product instance. Accordingly, there is one resource manager RM for every network technology as well. The resource managers RM are arranged to keep track of the status of available resources in a network, register new resources when building and installing new networks, deregister resources when removing resources and to book, connect and release network resources in connection with bookings deliveries and cancellations. The resource manager RM interacts with the resource register RR. The resource register RR stores data related to network resources, which resources comprises equipment, i.e. ports, channels, boards and interfaces, but also logic entities like network addresses and phone numbers. The technology manager TM exchanges information regarding the current network technology and adaption parameters and the required adaption functions needed for communication with operating systems, which is provided for different manufacturers of net elements and server systems, with the adaption layer L3 via the adaption interface I3.

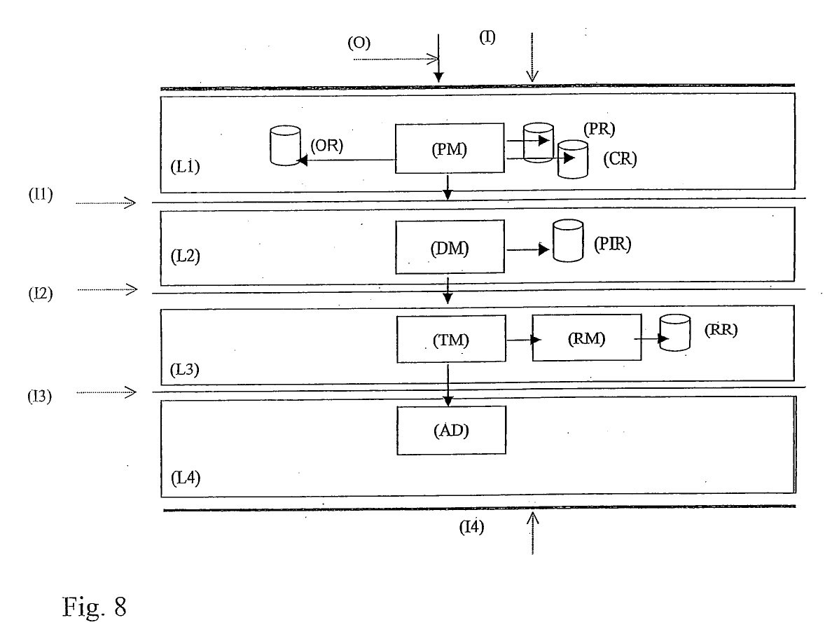

FIG. 8 shows a detailed description of the adaption layer L4. Adaption is a general name for function blocks supporting communication by adapting, or translating, protocols, command languages, data models etc. from one technology to another. The adaption is performed between a certain technology manager TM and a specific operating system. The network interface I4 is the interface towards the actual operating systems. A plurality of different operating systems, network systems and server systems exists, which makes the actual adaption different depending on the specific system that is to be adapted to. The network interface I4 towards the plurality of different operating systems, network systems and server systems consists of:
Carrier protocols available in a specific system in order to send a message.
Information models used by a specific system for interpreting an incoming message.
Communication protocols used to initiate, sustain and end a session towards a specific system.
   The adaption layer L4 performs the operation requested by the technology manager TM, for example book, connect or release resources belonging to a specific network element, in a specific rack, magazine, board interface etc. If the operation is performed accurately, the adaption layer will send a verification hereof to the calling technology manager TM. Thus, the final step has been reached, and the operation will move up through the layers again.

An alternative solution is to develop functions for each and every type of delivery, without employing an automated solution. This will require human operators at each interface to initiate input and monitor the process. This would imply an increase in human resources, it would be cost inefficient and it would affect the quality of the deliveries.

Those skilled in the art will realize that the different registers, managers and interfaces must not necessarily be located adjacent to each other, but can be geographically separated.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A control system in a system comprising a plurality of service providers and a plurality of network providers, which control system enables any service provider to order a product at any network provider and enables the network provider to manage information for delivering said product in a telecommunication network to the service provider, wherein the control system comprises:
means arranged to register a product type order, from a service provider, at a network provider;
means arranged to identify the network technology of the network provider for the ordered product type, based on predetermined registered network technology information;
means arranged to create and register an order based on said product type order from the service provider;
means arranged to translate the communication protocols that the service provider is using to the communication protocols of the network technology of the network provider, which translation is based on said predetermined registered network technology information; and
means arranged to deliver said product, in accordance with the registered order, to the service provider.

2. The control system according to claim 1, wherein the control system is arranged to coordinate a plurality of network technologies simultaneously, based on the predetermined registered network information, by translating the protocol of the service provider to the protocol of each and every one of these different network technologies.

3. The control system according to claim 1, wherein the control system is arranged to register and manage data associated with every product during the lifetime of the product.

4. The control system according to claim 1, wherein the control system is arranged to register data associated with installed network resources.

5. The control system according to claim 5, wherein the control system is arranged to monitor status about, book, connect and release said installed network resources, based on said registered data associated with the installed network resources.

6. The control system according to claim 1, wherein the control system is arranged to adapt the communication protocols that the service provider is using, to network elements included in the network technology, which network elements can have different versions, different manufacturers, be of different types and have different technical solutions, based on said predetermined registered network technology information.

7. The control system according to claim 1, wherein the control system means arranged to deliver said product, in accordance with the registered order, to the service provider, is arranged to change or cancel the delivery of said product.

8. The control system according to claim 1, wherein the control system is arranged to define a given product by means of forming the product using at least one predetermined registered data set.

9. A method in a system comprising a plurality of service providers and a plurality of network providers, which method enables any service provider to order a product at any network provider and enables the network provider to manage information for delivering said product in a telecommunication network to the service provider, wherein the method comprises the steps of:
registering a product type order from a service provider, at the network provider;
identifying the network technology of the network provider for the ordered product type, based on predetermined registered network technology information;
creating and registering an order based on said product type order from the service provider;
translating the communication protocols that the service provider is using, to the communication protocols of the network technology of the network provider, based on said predetermined registered network technology information; and
delivering said product, in accordance with the registered order, to the service provider.

10. The method according to claim 9, comprising the step of:
coordinating a plurality of network technologies simultaneously, based on the predetermined registered network information, by translating the protocol of the service provider to the protocol of each and every one of these different network technologies.

11. The method according to claim 9, comprising the step of:
registering and managing data associated with every product during the lifetime of the product.

12. The method according to claim 9, comprising the step of:
registering data associated with installed network resources.

13. The method according to claim 12, comprising the step of:
monitoring status about, book, connect and release said installed network resources, based on said registered data associated with the installed network resources.

14. The method according to claim 9, comprising the step of:
adapting the communication protocols that the service provider is using, to network elements included in the network technology, which network elements can have different versions, different manufacturers, be of different types and have different technical solutions, based on said predetermined registered network technology information.

15. The method according to claim 9, wherein the delivery of a product, in accordance with the registered order, to the service provider, can be changed or cancelled.

16. The method according to claim 9, wherein a given product is defined by means of forming the product using at least one predetermined registered data set.

17. A computer-readable medium storing computer-executable components for causing a unit to perform the steps recited in claim 9, when the computer-executable components are run on microprocessor included by the unit.
